(19) United States
(12) Patent Application Publication
(10) Pub. No.: US 2026/0213067 A1
(43) Pub. Date: Jul. 23, 2026

(54) Power Transfer Control Method in a Rotary Transformer

(71) Applicant: IRP NEXUS GROUP LTD, Nes Ziona (IL)

(72) Inventors: Shmuel BEN-YAACOV, Tel Yitzhak (IL); Yivgeni SEMIDOTSKIH, Ofakim (IL); Paul PRICE, Nes-Ziona (IL)

(21) Appl. No.: 18/876,484

(22) PCT Filed: Jun. 26, 2023
(86) PCT No.: PCT/IL2023/050656

§ 371 Date: Dec. 18, 2024

(30) Foreign Application Priority Data
Jun. 27, 2022 (IL) 294352

(51) Int. Cl. H01F 38/18; H01F 27/34; H01F 27/40; H01F 27/42

(52) U.S. Cl. CPC H01F 38/18; H01F 27/346; H01F 27/40; H01F 27/42

(57) ABSTRACT

A transformer with controlled power and data transfer between sides, comprising a primary section on one side and a secondary section on the other side with a first gap between the sections, via which power from the primary side is transferred to the secondary side, or vice versa; a capacitively coupled path, established between the primary and secondary sides, for transmitting data pulses to control the amount of power transfer; a first conductive strip with a loop structure and mounted in an electrically isolated form and away from the first gap, on the outer surface of the primary side of the transformer, to form a first looped electrode of the capacitive coupling; a second conductive strip with a loop structure and mounted in a concentric manner around the first trip, to form a second looped electrode of the capacitive coupling, such that the second conductive strip encircles the loop formed by the first conductive strip, the second conductive strip is physically connected, in an electrical isolated manner, to the second section of the transformer; a second gap between the opposing looped electrodes to obtain a desired capacitive coupling level; a pulse transmitter connected to one electrode and a receiver to the second electrode, to continuously transmit the data pulses from the pulse transmitter to the receiver, via the capacitively coupled path.

### FIELD OF THE INVENTION

The present invention relates to the field of electrical power and data transfer. More particularly, the present invention relates to a system and method for controlling bidirectional and bipolar power and data transfer by a rotary transformer to loads such as Direct Current (DC)-excited rotors of synchronous electric motors.

### BACKGROUND OF THE INVENTION

Synchronous motors are widespread and have many practical applications, such as powering electric cars. A synchronous electric motor is an AC motor in which, at steady state, the rotation of the rotor is synchronized with the frequency of the current supplied to the stator. The rotation frequency is equal to an integral number of AC cycles.

The rotation of the synchronous motor is a result of the interaction between the rotating magnetic field formed by the stator and the magnetic field of the rotor. The latter could be based on an array of permanent magnets or on wire wound coils that are fed by a DC current, to build the magnetic field of the rotor. DC-excited synchronous motors require the transfer of DC current to the rotating rotor.

FIG. 1 (prior art) schematically illustrates a simplified cross-sectional view of the DC-excited synchronous motor. The motor 100 consists of a stator 101 inside which a rotor 102 is mounted using bearings 103. Brushes 106 and slip-rings 105 are then used to feed current from a power supply 104 to the rotating rotor 102. However, using a combination of brushes and slip-rings is problematic, since they suffer from wear, as well as dirt that penetrates the moving contacts. In addition, some applications require inserting the motor into a fluid for cooling which may hamper the electrical conduction between the brushes and the slip rings.

One of the existing solutions for replacing the combination of brushes and slip-rings is using a rotary transformer, as shown in FIG. 2 (prior art). The rotary transformer 200 consists of two parts 201 and 202 with magnetic coupling between them.

Since a transformer (either stationary or rotary) can only pass AC voltage, transferring DC current to the rotor coils is done by first feeding the rotary transformer by an AC signal and then rectifying the output voltage, at the secondary of the transformer, using diodes, as shown in FIG. 3 (prior art). The rotor 102 may be described as a large inductor L_{R} with ohmic losses R_{R}. This way, current (electrical energy) is delivered from the primary side 30 to the secondary side 31 and into the rotor (L_{R}) in a controllable manner, in order to rotate the rotor at a desired speed. The array of diodes 300 is used to rectify the delivered AC current, in order to provide DC current to the rotor.

FIGS. 4A-4C (prior art) show typical required variations in the rotor current (on the left) and a synchronous bidirectional bridge at the secondary side (on the right). Basically, the current direction is kept positive (from the bridge into the rotor), but variations are needed for controlling the speed and torque of the motor (such as for electric cars).

FIG. 4A (left) shows a typical variation in the rotor current 301. An increase in the rotor current is obtained by increasing the amplitude of the AC voltage of the primary 30, while a decrease in the current is achieved by decreasing the amplitude of said AC voltage. The maximum rate of decrease, when the said AC voltage is zero is given by: I(t)=I₀e^{-t/τ} where τ=L_{R}/R_{R} (102)

Fast reducing of the current requires that the changing rate (dI/dt) will be negative (Vₐᵥ<V_{R}=IR_{R}, as shown in the graph of FIG. 4B (left, 302). However, the rate of current decrease with even zero voltage at the secondary of the rotary transformer, is controlled by the time constant of the rotor network (τ=L_{R}/R_{R}) resulting in practical cases in a slow rate of current decrease. Fast negative (dI/dt) requires a negative average voltage to be fed to the rotor. Since the diodes 300 can produce only a positive voltage, there is a need for an active synchronous rectification that can produce both positive and negative voltage as illustrated in FIG. 4C.

FIG. 4C (prior art) shows using switches such as ETs (or another type of circuit breakers) as a synchronous rectifier to control the rotor current. In this implementation, by properly controlling the switching scheme of Q1, Q2, Q3, Q4, with respect to the output voltage of the rotating transformer, it is possible to obtain both positive and negative output voltage. For example, if Q1 and Q4 will conduct when the signal coming out of the secondary side of the transformer is positive, the overall voltage across the rotor will be positive. On the other hand, if Q2 and Q3 will conduct, when the signal coming out of the secondary side of the transformer is positive, the overall voltage across the rotor will be negative and the current of the rotor decreases faster. Conversely, if the momentary voltage coming out of the secondary of the transformer is negative, Q1 and Q4 conduction will produce a negative voltage at the output, while Q2, Q3 conduction will produce a positive voltage. However, the operation of the synchronous rectifier requires a data link from the stator side to the rotor, to control the switches (Q₁-Q₄)

In other applications, power transfer is also required to be bipolar and bidirectional. For example, a battery needs to be charged before being discharged to the load. The problem to be solved is, therefore, how to deliver electrical power from the primary side to the secondary side and vice versa, along with the information (synchronization pulses) required for properly controlling the synchronous switches Q1-Q4 to obtain power transfer in the desired direction and rate. Furthermore, some applications call for data transfer from the rotating side to the stationary side for various parameters such as the value of the rotor current and/or its temperature. To solve this problem, other existing solutions use two channels such as two rotating transformers, one for delivering electrical power and one for sending the control commands in the form of synchronization pulses delivered from the primary side to the secondary side.

IL 283482 describes a possible arrangement using capacitive coupled open ring electrodes (to avoid circulating current) 160a and 160b, as shown in FIG. 5. In this case, the data pulses are coupled to the rotary transformer by capacitors 165 and 166 that transfer the high frequency components of the data signals 122. Open ring electrodes (one (160, a,b) or multi pair rings) are mounted on each surface 150a, 150b of the rotary transformer which implements the capacitive coupling, on top of an insulating layer 161, such that each insulating layer prevents contact between the open ring electrode (160a, 160b, or a multi electrode assembly) and the wires 151a, 151b of each side of the rotary transformer. This arrangement does not deteriorate the operation of the rotary transformer, since the presence of the open ring electrodes and the insulating layers is transparent to the magnetic flux between the windings at each side of the rotary transformer. However, the generated electric field within the transformer and the switching operations add substantial interference and noise to the data pulses. Filtering the noise requires very complicated filters accompanied by massive signal processing hardware, which are costly and difficult to realize.

It is therefore an object of the present invention to provide a system and method for controlling power and data transfer between sides of a rotary transformer, while reducing the noise on the data link(s) associated with switching and power transfer between the primary and the secondary sides of the rotary transformer.

It is another object of the present invention to provide a system and method for controlling power transfer between sides of a rotary transformer, while reducing the attenuation and losses of the control signals during transmission between sides.

Other objects and advantages of the invention will become apparent as the description proceeds.

### SUMMARY OF THE INVENTION

A method for controlling power and data transfer between sides of a transformer, comprising:
a) providing a transformer having a primary section on one side and a secondary section on the other side with a first gap between the sections;
b) transferring, via the first gap, power from the primary side to the secondary side, or vice versa;
c) establishing a capacitively coupled path for transmitting data pulses between the primary and secondary sides, to control the amount of power transfer, by:
   c.1) mounting, in an electrically isolated form and away from the first gap, a first conductive strip having a loop structure on the outer surface of the primary side of the transformer, to form a first looped electrode of the capacitive coupling;
   c2) mounting in a concentric manner, a second conductive strip having a loop structure around the first trip, to form a second looped electrode of the capacitive coupling, such that the second conductive strip encircles the loop formed by the first conductive strip, and physically connecting the second conductive strip, in an electrical isolated manner, to the second section of the transformer;
   c.3) determining a second gap between the opposing looped electrodes to obtain a desired capacitive coupling level;
   c.4) connecting a pulse transmitter to one electrode and a receiver to the second electrode; and
d) continuously transmitting the data pulses from the pulse transmitter to the receiver, via the capacitively coupled path.

The data pulses may be in the form of a square wave signal that passes via the transformer from the primary side to the secondary side, or of short pulses that pass via the transformer from the primary side to the secondary side and processed at the secondary side to reconstruct the square wave signal at the secondary side.

The power transfer between the sides of the transformer may be bidirectional.

The gap between opposing looped electrodes may be parallel to the rotation axis.

Whenever the opposing electrodes are ring electrodes, the gap between them may be perpendicular to the rotation axis.

The data pulses may be amplified before reaching the transmitting electrode and after passing transmitting electrode by single-ended operational amplifiers or by differential operational amplifiers.

The attenuation of the transmitted data pulses may be reduced by increasing the gap between the receiving electrode and its corresponding shielding layer.

The attenuation of the transmitted data pulses may be reduced by:
a) inserting a guard between the receiving electrode and its corresponding shielding layer, the guard being sandwiched between two insulating layers;
b) connecting the guard to an input of a unity gain operational amplifier; and
c) connecting the receiving electrode to the other input of the unity gain operational amplifier.

The transmitting electrode may be mounted on the rotor and the receiving may be mounted on the stator.

The transformer may be a rotary transformer having a gap between sections for allowing rotation of the primary side relative to the secondary side, or vice versa.

A transformer having controlled power and data transfer between sides, comprising:
a) a primary section on one side and a secondary section on the other side with a first gap between the sections, via which power from the primary side is transferred to the secondary side, or vice versa;
b) a capacitively coupled path, established between the primary and secondary sides, for transmitting data pulses to control the amount of power transfer;
c) a first conductive strip having a loop structure and mounted in an electrically isolated form and away from the first gap, on the outer surface of the primary side of the transformer, to form a first looped electrode of the capacitive coupling;
d) a second conductive strip having a loop structure and mounted in a concentric manner around the first trip, to form a second looped electrode of the capacitive coupling, such that the second conductive strip encircles the loop formed by the first conductive strip, the second conductive strip is physically connected, in an electrical isolated manner, to the second section of the transformer;
e) a second gap between the opposing looped electrodes to obtain a desired capacitive coupling level; and
f) a pulse transmitter connected to one electrode and a receiver to the second electrode, to continuously transmit the data pulses from the pulse transmitter to the receiver, via the capacitively coupled path.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 (prior art) schematically illustrates a simplified cross-sectional view of DC-excited synchronous electric motors;

FIG. 2 (prior art) shows existing solutions for replacing the combination of brushes and slip-rings is using a rotary transformer;

FIG. 3 (prior art) shows a rotary transformer used to feed DC current into the rotor by rectifying an AC current using diodes;

FIGS. 4A-4C (prior art) show typical required variations in the rotor current (left side) and a synchronous bidirectional bridge at the secondary side (right side);

FIG. 5 shows a further improvement of passing the data (command) signals from the primary side to the secondary side by using capacitive coupled open ring electrodes;

FIG. 6 is a schematic illustration of a circuitry for parallel implementation of capacitive ring electrodes on the outer surface of a rotary transformer;

FIG. 7 illustrates another implementation which is essentially similar to FIG. 6, where the insulating surfaces are implemented in a vertical orientations over the stator and the rotor transformer sections;

FIG. 8 is a schematic view of a basic circuit for conveying the data pulses from the stator (primary) side to the rotor (secondary) side via capacitive coupling;

FIG. 9 shows an arrangement, where the transmission of pulses at the primary side and the reception of pulses at the secondary side are differential;

FIG. 10 illustrates an equivalent representation of the transmission path in the arrangement of FIG. 9 including parasitic capacitances;

FIG. 11 is an equivalent circuit of the circuit of FIG. 10;

FIG. 12 shows moving the shielding conductive surface from the corresponding conducting electrode of the secondary side, in order to reduce the loading capacitance;

FIG. 13 shows the general principle of the Miller effect to reduce the input capacitance at the input of an amplifier;

FIG. 14 illustrates the use of a conductive guard layer to reduce the unwanted attenuation by the Miller effect in a differential connection;

FIG. 15a shows the capacitances that are present with the implementation of a conductive guard;

FIG. 15b illustrates an equivalent circuit of the secondary side shown in FIG. 15a; and

FIG. 16 shows the equivalent impedances while considering the receiving electrode and the guard.

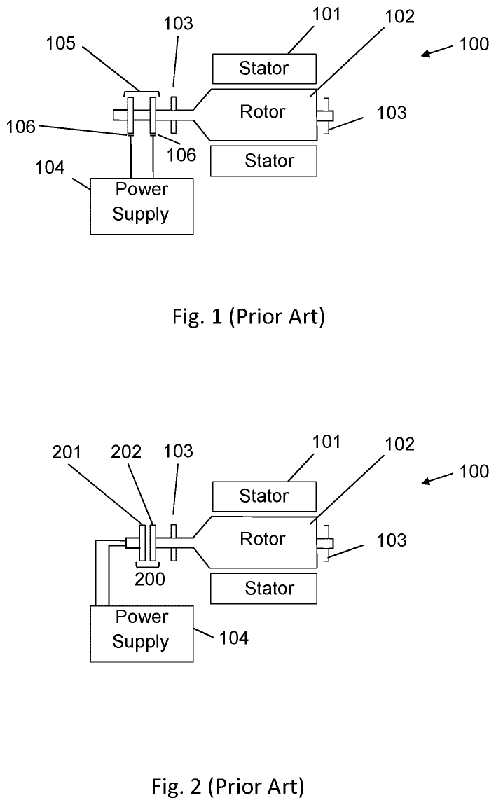

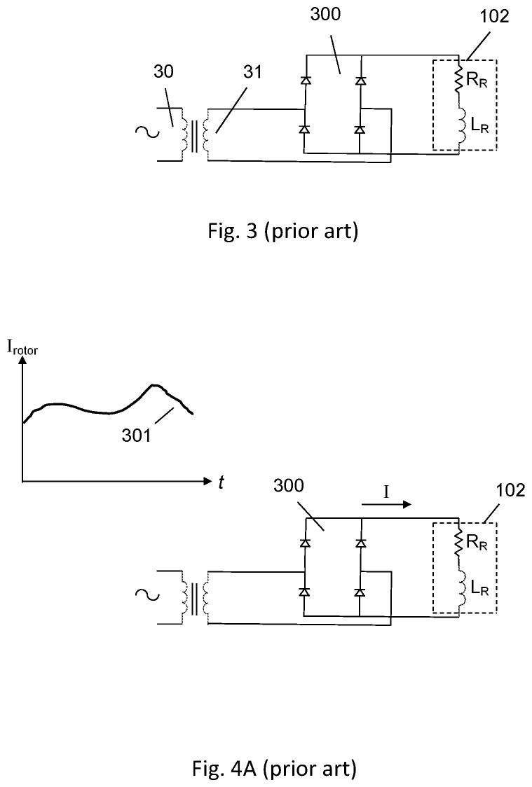

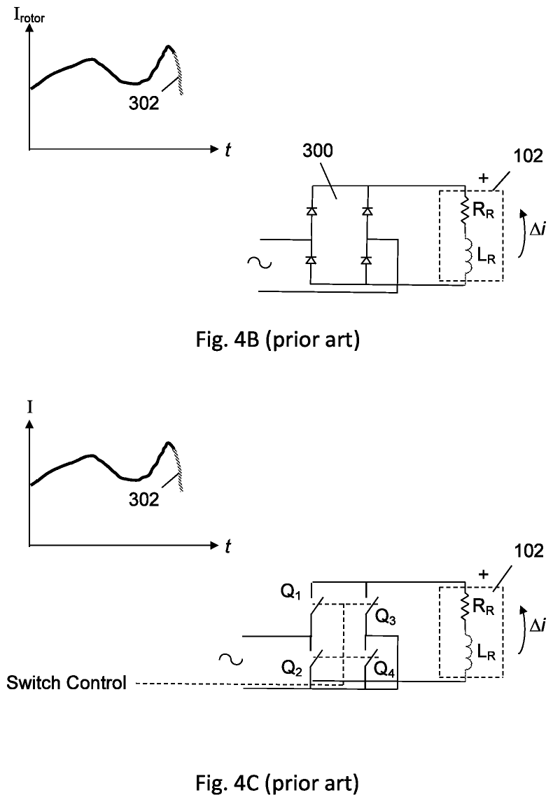

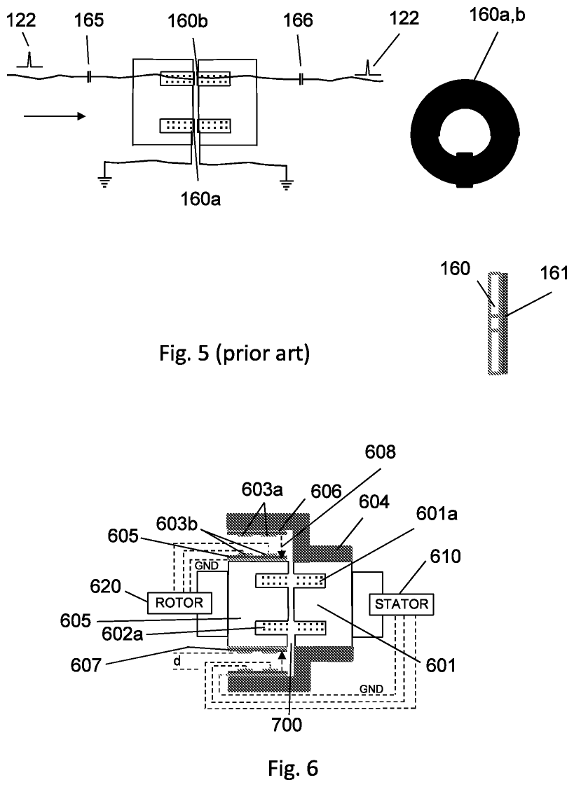

### DETAILED DESCRIPTION OF THE PRESENT INVENTION

The present invention proposes a system and method for implementing a bidirectional data transfer via a transformer (such as a rotary transformer) that is used to transfer power in a non-galvanic way to a stationary or rotating load, such as a rotor of an electric motor, as well as to other rotary and non-rotary systems that require power transfer. The proposed method is reliable in that it reduces the noise injection associated with the switching and power signal of the rotary transformer.

FIG. 6 is a schematic illustration of a circuitry for parallel implementation of capacitive ring electrodes on the outer surface of a transformer for data transfer via a rotating or stationary transformer (600), according to an embodiment of the invention. In this implementation, the electrical power is delivered via magnetic coupling between the two sections of a power transformer (a primary section 601, and a secondary section 605), while the data pulses (that may be in the form of a square wave signal) are transferred from the primary to the secondary side via capacitive coupling via a capacitively coupled path 608. The data pulses may be in the form of short pulses that pass via the transformer from the primary side to the secondary side and processed at the secondary side to reconstruct the square wave signal at the secondary side. The electrodes that form the coupling capacitance of the capacitively coupled path 608 are away and electrically isolated from the magnetic field of the transformer, formed in the first gap 700, in order to decrease the noise injected into the data link. The transformer 600 consists of a primary side 601, with the winding 601a, that is fed by the source such as a stator 610 and a secondary side 605 with corresponding wire turns 602a, which is connected to the load. In this example, the rotary dual active bridge is a round rotary transformer 600 and the wire turns in the primary and secondary sides (601a and 602a, respectively) are shown in a cross-sectional view, along with the air gap 700 between them. The ring electrodes 603a (of the primary side) and 603b (of the secondary side) are mounted over non-conductive (insulating) surfaces 604 and 605, respectively, where each looped electrode is in the form of a (first and second) round conductive strip (with a looped structure). The second conductive strip is physically connected to the second section of the transformer, in an electrical isolated manner. The fixed gap d between the opposing looped electrodes is parallel to the rotation axis and maintains the required capacitive coupling. Ground planes 606 and 607 of the primary and secondary, respectively, are used to further shield the data link from injected noise, are also formed on the corresponding insulating surfaces (604, 605). In this arrangement, the width of each conducting strip may be increased (for adjusting the coupling) up to the maximum size allowed by the length of the transformer's secondary side, without increasing the size of the structure. I would be clear to a person skilled in the art, that alternatively, the electrode assembly can be flipped with the cover 604 attached to the secondary part of the transformer.

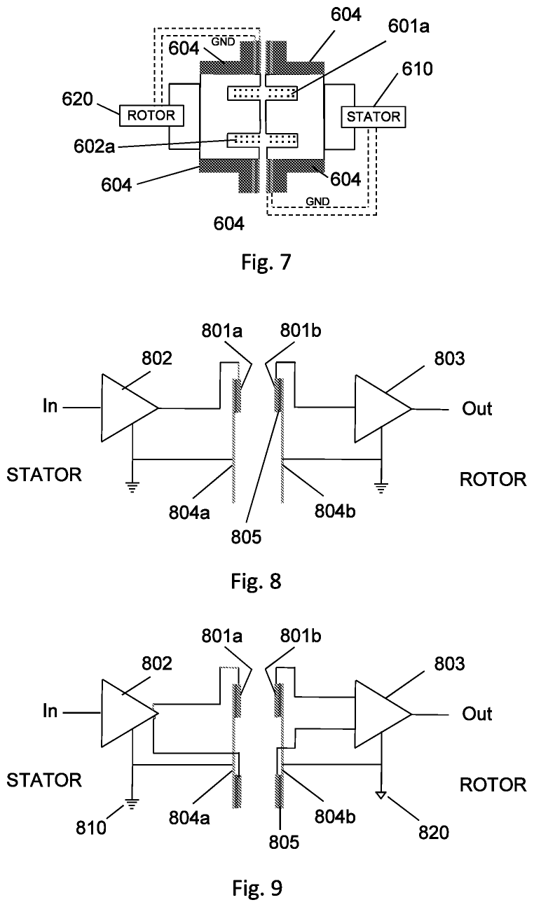

FIG. 7 illustrates another implementation which is essentially similar to FIG. 6, while the electrodes 603a, 603b, are placed perpendicularly to the outer surface of the transformer. In this case, the width of the electrode, which linearly affects the inductance of the coupling capacitor, can be made larger.

In this example, the insulating surface 604 is wrapped around the rotor core while the insulating surface 605 is wrapped around the stator core. Of course, an opposite arrangement may be implemented similarly, as well.

FIG. 8 is a basic circuit diagram of an electronic circuit for conveying the data link pulses from the primary side to the secondary side via capacitive coupling. In this configuration, there is a first electrode 801a in the primary side and a second electrode 801b in the secondary side. The data pulses are transmitted via a driver 802 and the passing signals are amplified by an amplifier 803 at the secondary side.

In order to prevent incoming noise and interference signals from reaching the transmitted pulses, shielding conductive surfaces 804a and 804b are added, close to each electrode, where shielding conductive surface 804a is connected to the ground of the primary side and shielding conductive surface 804b is connected to the ground of the secondary side. Each electrode is mounted to the corresponding shielding conductive surface via an insulating layer 805.

In order to further improve the reduction of interference signals, in the practical case where there is a potential difference between the ‘ground’ of the primary side 810 and the ‘ground’ of the secondary side 820, the data pulses may be transmitted from the primary side to the secondary side (or vice versa) via differential amplifiers. This arrangement is shown in FIG. 9, where the transmission of pulses at the primary side and the reception of pulses at the secondary side will be differential.

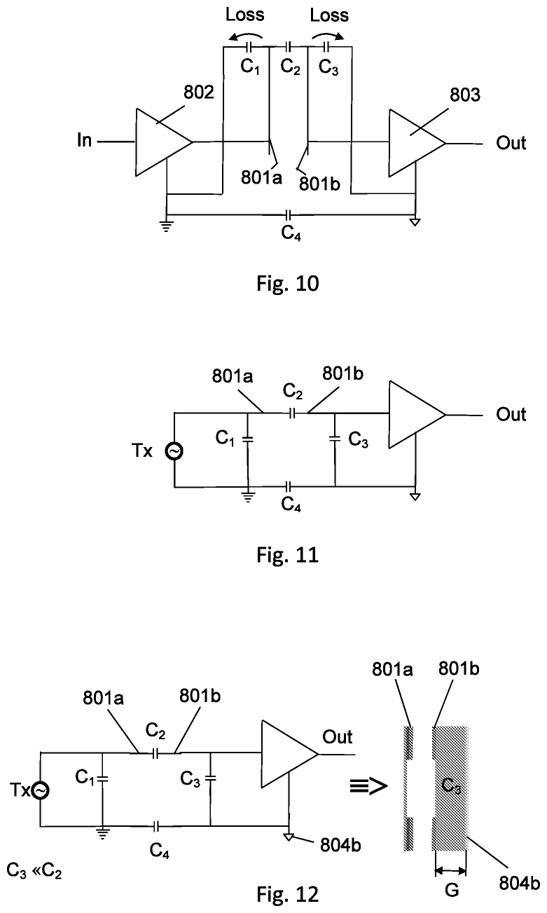

FIG. 10 illustrates an equivalent circuit representation of the transmission path in the arrangement of FIG. 9. The capacitive coupling between sides is represented by C2. However, the presence of each insulating layer entails unwanted capacitances, C1 and C3, which cause signal losses. C4 represent the capacitance between the ‘grounds’ 810, 820.

FIG. 11 is an equivalent circuit of the circuit of FIG. 10. Tx is a transmitter loaded by capacitance C₁ to ground. The coupling capacitor C₂, might have small capacitance, as determined by the area of the electrodes and the distance between them. C₃ represents the capacitance at the input of the receiver's amplifier, and forms a voltage divider with C₂, which attenuates the transmitted pulses. Therefore, in order to reduce this unwanted attenuation, C₃ should be substantially lower than C₂. This can be achieved by moving away by some distance G the shielding conductive surface 804b (FIG. 8) from the corresponding conducting electrode 801b of the secondary side (in order to reduce the capacitance of C₃), as shown in FIG. 12. The gap G between the shield 804b and the electrode 801b may be filled with a nonconductive filler with low dielectric constant ε, in order to keep the inductance of C₃ as small as possible (since C3=(ε·A)/G, where A is the area of the electrode 801b).

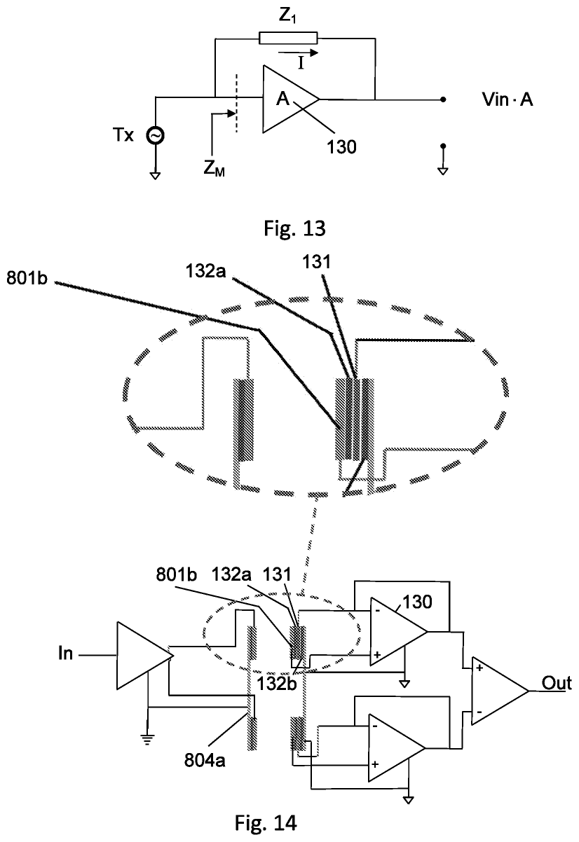

FIG. 13 shows a general representation of the Miller Effect that can be used to reduce the reflected value of an impedance Z. If the impedance Z₁ is connected between the input and the output of an amplifier having a gain A, if the input voltage is Vin, the output voltage will be Vin·A and the current I via Z₁ will be: I=Vin·(1−A)/Z₁. Therefore, the Miller impedance Z_{M} reflected at the input of the amplifier 130 will be:

$${Z}_{M} = V in / I = Z 1 ( 1 - A )$$

Hence, if the amplifier's gain is near unity (A=1) the reflected ZM will approach 0Ω.

FIG. 14 illustrates the use of a conductive guard layer to reduce the unwanted attenuation, based on the Miller effect. The receiving electrode 801b is connected to an input of an operational amplifier 130 with unity gain. Therefore, the voltage at the output of operational amplifier 130 is identical to the voltage on the receiving electrode 801b. The other input of the operational amplifier 130 is connected to a guard 131 (sandwiched between two insulating layers 132a and 132b), which is inserted between the receiving electrode 801b and its corresponding shielding (layer) surface 804b. By doing so, the signal loss due to the divider C₂, C₃ (FIG. 12) is reduced appreciably.

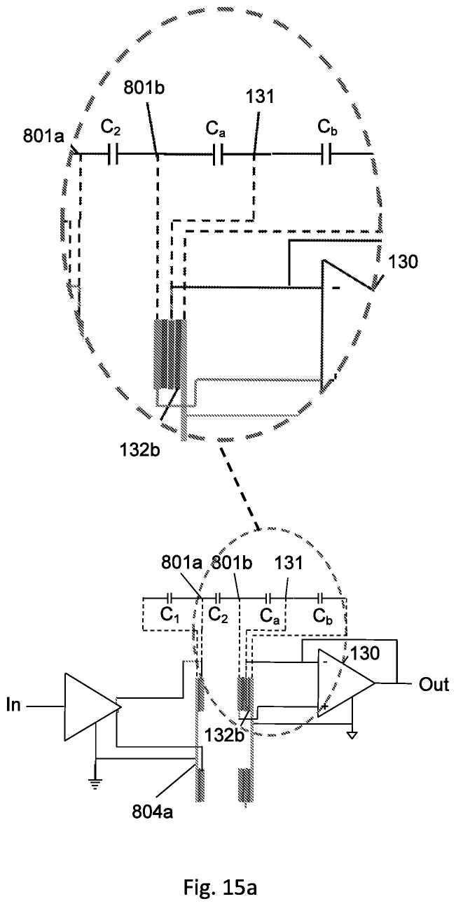

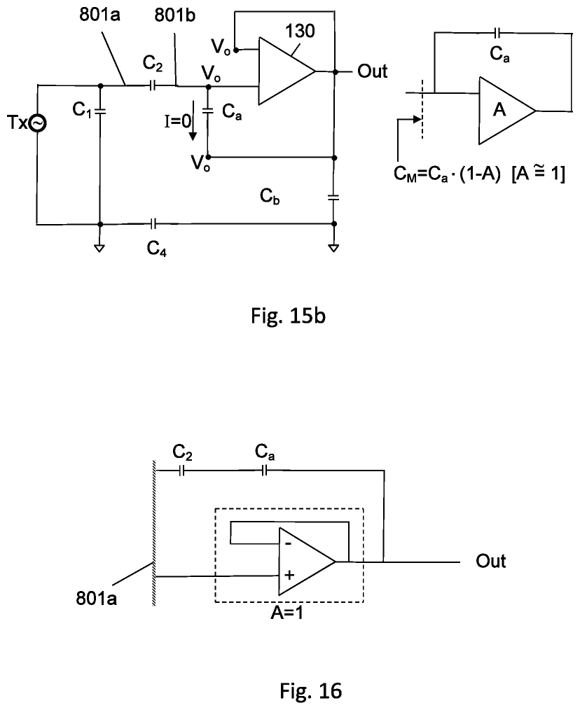

FIG. 15a shows the capacitances C₁, C₂, Ca and Cb that are present with the implementation of the guard 131. C1 represents the capacitance (to ground) that loads the transmitting electrode 801a. C₂ is the coupling capacitance between the transmitting and the receiving electrodes. Ca represents the capacitance over the receiving electrode 801b and the guard 131. Since the amplifier 130 has a unity gain, the voltage across Ca is zero. Cb represents the capacitance over the shielding plate 805.

FIG. 15b illustrates an equivalent circuit diagram of the secondary side shown in FIG. 15a. The transmitting amplifier (at the primary side) is represented by voltage source 140, which is loaded by capacitor C₁. C₂ is the coupling capacitor and Ca is the capacitance between the guard 131 and the input of the output amplifier 130. Since the voltage across Ca is zero, no current will flow through Ca and therefore, Ca introduces a very large equivalent impedance (C_{M}, according to Miller effect as shown on the right of FIG. 15b) which does not load and therefore, reduces the attenuation of the transmitted signals.

FIG. 16 shows the equivalent impedances while considering the receiving electrode 801b and the guard 131. Since in this case A=1, Z_{M} will approach zero.

This arrangement of using a combination of a guard and shielding electrodes allows maintaining a high gain for the signals received by the receiving electrode 801b. The equivalent capacitance Cb resulting from shielding actually loads the amplifier 130 and therefore, needs to have sufficient gain.

The above examples and description have of course been provided only for the purpose of illustrations, and are not intended to limit the invention in any way. As will be appreciated by the skilled person, the invention can be carried out in a great variety of ways, employing more than one technique from those described above, all without exceeding the scope of the invention.

1. A method for controlling power and data transfer between sides of a transformer, comprising:
a) providing a transformer having a primary section on one side and a secondary section on the other side with a first gap between said sections;
b) transferring, via said first gap, power from said primary side to said secondary side, or vice versa;
c) establishing a capacitively coupled path for transmitting data pulses between said primary and secondary sides, to control the amount of power transfer, by:
i) mounting, in an electrically isolated form and away from said first gap, a first conductive strip having a loop structure on the outer surface of the primary side of said transformer, to form a first looped electrode of the capacitive coupling;
ii) mounting in a concentric manner, a second conductive strip having a loop structure around said first strip, to form a second looped electrode of the capacitive coupling, such that said second conductive strip encircles the loop formed by said first conductive strip, and physically connecting said second conductive strip, in an electrical isolated manner, to the second section of said transformer;
iii) determining a second gap between said opposing looped electrodes to obtain a desired capacitive coupling level;
iv) connecting a pulse transmitter to one electrode and a receiver to the second electrode; and
d) continuously transmitting said data pulses from said pulse transmitter to said receiver, via said capacitively coupled path.

2. The method according to claim 1, wherein the data pulses are in the form of a square wave signal that passes via the transformer from the primary side to the secondary side.

3. The method according to claim 2, wherein the data pulses are in the form of short pulses that pass via the transformer from the primary side to the secondary side and processed at said secondary side to reconstruct the square wave signal at said secondary side.

4. The method according to claim 1, wherein the power transfer between the sides of the transformer is bidirectional.

5. The method according to claim 1, wherein the gap between opposing looped electrodes is parallel to the rotation axis.

6. The method according to claim 1, wherein the opposing electrodes are ring electrodes, the gap between which is perpendicular to the rotation axis.

7. The method according to claim 1, wherein the data pulses are amplified before reaching the transmitting electrode and after passing transmitting electrode by single-ended operational amplifiers.

8. The method according to claim 1, wherein the data pulses are amplified before reaching the transmitting electrode and after passing transmitting electrode by differential operational amplifiers.

9. The method according to claim 1, further comprising reducing the attenuation of the transmitted data pulses by increasing the gap between the receiving electrode and its corresponding shielding layer.

10. The method according to claim 1, further comprising reducing the attenuation of the transmitted data pulses by:
a) inserting a guard between the receiving electrode and its corresponding shielding layer, said guard being sandwiched between two insulating layers;
b) connecting said guard to an input of a unity gain operational amplifier; and
c) connecting said receiving electrode to the other input of said unity gain operational amplifier.

11. The method according to claim 1, wherein the transmitting electrode is mounted on the rotor and the receiving is mounted on the stator.

12. The method according to claim 1, wherein the transformer is a rotary transformer having a gap between sections for allowing rotation of the primary side relative to the secondary side, or vice versa.

13. A transformer having controlled power and data transfer between sides, comprising:
a) a primary section on one side and a secondary section on the other side with a first gap between said sections, via which power from said primary side is transferred to said secondary side, or vice versa;
b) a capacitively coupled path, established between said primary and secondary sides, for transmitting data pulses to control the amount of power transfer;
c) a first conductive strip having a loop structure and mounted in an electrically isolated form and away from said first gap, on the outer surface of the primary side of said transformer, to form a first looped electrode of the capacitive coupling;
d) a second conductive strip having a loop structure and mounted in a concentric manner around said first strip, to form a second looped electrode of the capacitive coupling, such that said second conductive strip encircles the loop formed by said first conductive strip, said second conductive strip is physically connected, in an electrical isolated manner, to the second section of said transformer;
e) a second gap between said opposing looped electrodes to obtain a desired capacitive coupling level; and
f) a pulse transmitter connected to one electrode and a receiver to the second electrode, to continuously transmit said data pulses from said pulse transmitter to said receiver, via said capacitively coupled path.

14. The transformer according to claim 13, in which the data pulses are in the form of a square wave signal that passes via the transformer from the primary side to the secondary side.

15. The transformer according to claim 14, in which the data pulses are in the form of short pulses that pass via the transformer from the primary side to the secondary side and processed at said secondary side to reconstruct the square wave signal at said secondary side.

16. The transformer according to claim 13, in which the power transfer between the sides of the transformer is bidirectional.

17. The transformer according to claim 13, in which the gap between opposing looped electrodes is parallel to the rotation axis.

18. The transformer according to claim 13, in which the opposing electrodes are ring electrodes, the gap between which is perpendicular to the rotation axis.

19. The transformer according to claim 13, in which the data pulses are amplified before reaching the transmitting electrode and after passing transmitting electrode by single-ended operational amplifiers.

20. The transformer according to claim 13, in which the data pulses are amplified before reaching the transmitting electrode and after passing transmitting electrode by differential operational amplifiers.

21. The transformer according to claim 13, in which the attenuation of the transmitted data pulses is reducing by increasing the gap between the receiving electrode and its corresponding shielding layer.

22. The transformer according to claim 13, further comprising a guard being inserted between the receiving electrode and its corresponding shielding layer, said guard being sandwiched between two insulating layers and being connected to an input of a unity gain operational amplifier, wherein said receiving electrode is connected to the other input of said unity gain operational amplifier.

23. The transformer according to claim 13, in which the transmitting electrode is mounted on the rotor and the receiving is mounted on the stator.

24. The transformer according to claim 13, in which the transformer is a rotary transformer having a gap between sections for allowing rotation of the primary side relative to the secondary side, or vice versa.
